(19) United States
(12) Patent Application Publication
(10) Pub. No.: US 2002/0051837 A1
(43) Pub. Date: May 2, 2002

(54) Snack bar

(76) Inventor: Christopher Randall Beharry, Cincinnati, OH (US)

Correspondence Address: THE PROCTER & GAMBLE COMPANY, PATENT DIVISION, IVORYDALE TECHNICAL CENTER - BOX 474, 5299 SPRING GROVE AVENUE, CINCINNATI, OH, 45217, US

(21) Appl. No.: 09/923,210

(22) Filed: Aug. 6, 2001

Related U.S. Application Data
(60) Provisional application No. 60/223,846, filed on Aug. 8, 2000.

(51) Int. Cl. A23L 1/20

(52) U.S. Cl. 426/94; 426/633

(57) ABSTRACT

Snack bars having nut spread fillings are disclosed. The nut spread fillings are moist and creamy and do not require a crystallization step to achieve the desired firmness. The snack bars have the desired nut flavor intensity and creamy texture.

### CROSS REFERENCE TO RELATED APPLICATIONS

This application claims the benefit of priority to U.S. Provisional Application Serial No. 60/223,846, filed Aug. 8, 2000, which is herein incorporated by reference.

### TECHNICAL FIELD

This invention relates to snack bars having nut spread fillings. More specifically, it relates to such snack bars having high levels of nut spread fillings.

### BACKGROUND

Snack bars are very popular with consumers. The portability and convenience of such bars make them appealing food items. The composition of snack bars varies widely, and many of these snack bars comprise ingredients such as nuts, grains, confectionery products, granola, fruits, or the like. Also popular are snack bars comprising a nut spread such as peanut butter.

When making a snack bar comprising a nut spread, many problems are encountered. Conventional peanut butters are too soft to form a bar and are prone to oil separation when incorporated into confectionery centers or snack bar products, due to the destruction of the crystalline network inherent in the mixing steps typically used in manufacturing. In the past, these problems have been solved by two primary means: (1) decreasing the fluidity of the nut spread by significantly increasing the solids content, and/or (2) creating a secondary structure to hold and bind the nut spread in the product. Increasing the solids content typically has been accomplished by adding solid powdered materials such as corn syrup solids, powdered sugar, brown sugar, crushed graham crackers, or the like to the nut spread. Creating a secondary structure has typically been accomplished through the addition and re-crystallization of sugar-based products such as marshmallows or corn syrup solids, or through the addition and crystallization of high levels of products high in solid fat such as chocolate chips or butterscotch chips to the nut spread.

Although these approaches provide solutions to structural strength and overcome the oil separation problem, they also unfortunately “dilute” the nut spread and provide a snack bar with less than the desired nut flavor intensity and creaminess. Rather, the resulting snack bars are typified by a loss of distinctive nut flavor and have textures that are crumbly and less than desirable. Typically, the level of nut spread in these snack bars is less than 30% (e.g., particularly if the bar is enrobed with a confectioner's coating material), with the nut spread-containing portion of the bar (the “center”) comprising less than 45% nut spread.

Accordingly, it would be desirable to provide a stable and firm snack bar comprising a high level of a nut spread, preferably peanut butter, wherein the snack bar has the desired nut flavor intensity and creamy texture.

### SUMMARY OF THE INVENTION

The present invention provides a stable and firm snack bar comprising a high level of a nut spread, preferably peanut butter. The snack bar has a high level of nut flavor and the nut spread therein has a creamy texture.

The center of the snack bar comprises at least about 45%, more preferably from about 60% to about 95% nut spread, preferably peanut butter. The nut spread comprises a sufficient quantity of stabilizer to form a super-stabilized nut spread having a penetration value (firmness) measured by a Precision Universal Penetrometer of from about 130 to about 300, preferably from about 150 to about 250, penetration units (mm/10) at 21° C.

The center of the snack bar comprises from about 50 ml to about 250 ml, preferably from about 100 ml to about 200 ml, of food bits per 100 g of the total weight of the center (comprising food bits+super-stabilized nut spread). When combined with food bits, the nut spread retains its nut spread flavor and creaminess, yet has the desired structural strength for bar formation and stability against oil separation. Furthermore, the addition of food bits to the nut spread reduces the amount of stabilizer that must be added to the nut spread, thus avoiding a waxy mouthfeel. The density of the snack bar center is preferably from about 0.5 to about 1.25 g/ml, more preferably from about 0.6 to about 1.1 g/ml.

Preferably, the snack bar is further enrobed with a confectioner's material. The enrobed snack bar comprises greater than about 30%, preferably from about 45% to about 80%, nut spread.

### DETAILED DESCRIPTION OF THE INVENTION

A. Definitions

As used herein, a food bit is an edible food piece that has a size from about ⅛ inch (0.32 cm) to about ½ inch (1.3 cm) in its largest dimension.

While this invention will be generally described in terms of peanuts and peanut butter, it should be readily apparent that other nuts and oil seeds such as, but not limited to, almonds, pecans, walnuts, cashews, filberts, macadamia nuts, Brazilians, sunflower seeds, sesame seeds, pumpkin seeds, soybeans, and the like can be utilized in this invention. The term “nut” as used herein encompasses nuts and oil seeds, as well as mixtures thereof.

As used herein, the term “nut spread” means a spreadable food product comprising a mixture of nut solids and fat/oil, plus other optional ingredients such as, but not limited to, nut butter stabilizers, flavorants, flavor enhancers, bulking agents, emulsifiers, and mixtures thereof. Nut spreads include, but are not limited to, “peanut spreads” and “peanut butters” as these terms are defined by the standards of identity of the U.S. Food and Drug Administration.

As used herein, the term “total fat” refers to the total amount of fat and oil present in the nut spread. While the terms “fat” and “oil” are used somewhat interchangeably, the term “fat” usually refers to triglycerides (and their corresponding substitutes) that are solid or plastic at ambient temperature, while the term “oil” usually refers to triglycerides (and their corresponding substitutes) that are liquid or fluid at ambient temperature.

As used herein, all percentages (%) are by weight, unless otherwise indicated.

As used herein, “enrobed” means coated on one or more sides.

As used herein, “super-stabilized” means that the nut spread can be crystallized at ambient temperatures without the need for mechanical freezing.

As used herein, “stabilizer” means any edible fat or combination of fats that are solid at room temperature (˜70° F. (˜21° C.)), which when solidified in the nut butter keep the oil from separating and/or provide structural stability.

As used herein, “added stabilizer” is stabilizer that is added over and above any stabilizer already present in the nut spread.

B. Preparation of the Snack Bar

1. Providing a Nut Spread

Nut spreads are fluid suspensions or mixtures of finely divided solids (nut solids, sugar, protein, salt, etc.) and oil. These mixtures are also substantially free of moisture.

The nut spread ranges from approximately 30% to 60% oil. Oil is defined as any triglyceride compound from vegetable sources and their corresponding substitutes, such as sucrose polyesters (e.g., olestra).

Any suitable nut spread can be used for making the snack bar herein. Examples of suitable nut spreads include those described in U.S. Pat. No. 5,942,275 issued Aug. 24, 1999, to Wong et al.; U.S. Pat. No. 5,885,646, issued Mar. 23, 1999 to Wong et al.; U.S. Pat. No. 5,885,645, issued Mar. 23, 1999 to Wong et al.; U.S. Pat. No. 5,714,193 issued Feb. 3, 1998 to Fix et al.; U.S. Pat. No. 5,693,357 issued Dec. 2, 1997 to Wong et al.; U.S. Pat. No. 5,667,838 issued Sep. 16, 1997 to Wong et al.; U.S. Pat. No. 5,518,755 issued May 21, 1996 to Wong et al.; U.S. Pat. No. 5,508,057 issued Apr. 16, 1996 to Wong et al.; U.S. Pat. No. 5,490,999, issued Feb. 13, 1996 to Villagran et al.; U.S. Pat. No. 5,433,970 issued Jul. 18, 1995 to Wong et al.; U.S. Pat. No. 5,230,919 issued Jul. 27, 1993 to Walling et al.; U.S. Pat. No. 5,079,027, issued Jan. 7, 1992 to Wong et al.; U.S. Pat. No. 3,265,507, issued Aug. 9, 1966 to Japikse; U.S. Pat. No. 3,129,102 to Sanders; U.S. Pat. No. 1,395,934 issued Nov. 1, 1921 to Stockton; U.S. Pat. No. 2,504,620 issued Apr. 18, 1950 to Avera; U.S. Pat. No. 2,521,243 issued Sep. 5, 1950 to Mitchell; U.S. Pat. No. 2,562,630 issued Jul. 31, 1951 to Mitchell; U.S. Pat. No. 2,552,925 issued May 15, 1951 to Avera; co-pending U.S. application Ser. No. 09/511,058 filed Feb. 23, 2000 by Wong et al. entitled “Peanut Butter with Improved Flavor and Texture”; and co-pending U.S. Provisional Application Serial No. 60/192,813 filed Mar. 29, 2000 by Wong et al. entitled “Low Fat Nut Spread Composition with High Protein and Fiber”; all of which are herein incorporated by reference. Especially preferred nut spreads are those available from the Procter & Gamble Company of Cincinnati, Ohio, under the brand names Jif®, Reduced Fat Jif®, Jif Smooth Sensations®, and Simply Jif®.

Nut spreads are typically prone to oil separation unless a combination of a crystalline fat stabilizer followed by rapid cooling is used in their preparation. Thus, from about 1% to about 3% stabilizer is typically included in nut spreads. Such nut spreads, sufficiently stabilized for use as spread products, however, are too soft to form a snack bar and continue to be prone to oil separation when incorporated into confectionery centers or snack bar products due to the destruction of the crystalline network inherent in the mixing steps and/or heating steps used in confectionery manufacturing.

2. Preparation of the Super-Stabilized Nut Spread

The nut spread is melted such that all fat crystalline structure present as a result of prior stabilization is destroyed. Typically, this requires temperatures in the range of from about 140° F. (60° C.) to about 180° F. (82° C.) to be reached. Care should be taken not to overheat the melted nut spread, since heat sensitive flavor components may be damaged.

To the melted nut spread, additional stabilizer is added. Preferably, the stabilizer is melted before being added to the melted nut spread to aid in distribution and to minimize mix time. The nut spread and stabilizer are thoroughly mixed to form a homogeneous, super-stabilized nut spread. The super-stabilized nut spread is cooled to room temperature (˜70° F. (˜21° C.)).

A sufficient quantity of stabilizer is added such that the super-stabilized nut spread has a penetration value (firmness) measured by a Precision Universal Penetrometer of from about 130 to about 300, preferably from about 150 to about 250, penetration units (mm/10) at 21° C., as measured in the Analytical Methods Section herein. The penetration value is measured by taking fully melted super-stabilized nut spread and allowing it to cool in a manner representative of the cooling time and temperature that would be used when making a finished bar. This cooling profile is generally slow (minutes) compared to that achieved via mechanical cooling (seconds).

As the stabilizer level increases and the product firmness increases, the rate that the super-stabilized nut spread melts or breaks down in the mouth slows down. When higher levels of stabilizer are used, the super-stabilized nut spread tends to develop a waxy mouthfeel, causing a negative texture preference and a suppression of nut flavor display. Thus, the minimum amount of stabilizer necessary to achieve the desired structural strength and prevention of oil separation should be used.

Typically, from about 1% to about 4% added stabilizer is added to the nut spread to form a super-stabilized nut spread. The nut spread stabilizer can be any of the known peanut butter stabilizers, for example, hydrogenated rapeseed oil or other hydrogenated triglycerides having a high proportion of C₂₀ and C₂₂ fatty acids. For example, see U.S. Pat. No. 3,265,507, issued Aug. 9, 1966 to Japikse, and U.S. Pat. No. 3,129,102, issued Apr. 14, 1964 to Sanders, which are herein incorporated by reference.

These stabilizers are usually triglycerides which are solid at room temperature (˜70° F. (˜21° C.)). They solidify in the nut spread in specific crystalline states and keep the oil from separating. These materials can be mixed with a second hydrogenated oil having an iodine value of less than 8, for example hydrogenated palm oil, canola oil, soybean oil, rapeseed oil, cottonseed oil, coconut oil and similar materials. The stabilizer can also be mixed with lower melting fat fractions as, for example, the peanut butter stabilizer composition disclosed in U.S. Pat. No. 4,341,814, issued Jul. 27, 1982 to McCoy, which is herein incorporated by reference. Other suitable nut butter stabilizers include tailored β′ stable hardstocks, referred to as “PSP/PSS” hardstocks, as disclosed in U.S. Pat. No. 4,996,074, issued Feb. 26, 1991 to Seiden et al., which is herein incorporated by reference.

Alternatively, the additional stabilizer can be added to the nut spread during its initial manufacture to create the super-stabilized nut spread directly.

The super-stabilized nut spread can be used to produce the food bar of the present invention while still in its melted state; alternatively, the super-stabilized nut spread can be allowed to cool and set up to be used at a later time.

3. Addition of Food Bits to the Super-Stabilized Nut Spread to Form the Snack Bar Center

Food bits are added to the super-stabilized nut spread. As used herein, a food bit is an edible food piece that has a size from about ⅛ inch (0.32 cm) to about ½ inch (1.3 cm) in its largest dimension. The food bits should be fairly rigid in nature so as to provide rigidity to the overall structure. The particle size distribution of the food bits has an impact on the overall system rigidity due to particle packing tendencies. While not the overriding control factor, in general, bits with a wide range of particle distributions will create a stronger structure than bits of uniform particle sizes. Thus, the inclusion of food bits provides structural stability and decreased tackiness such that lower levels of stabilizer are required, thus avoiding a waxy mouthfeel.

Suitable food bits include, but are not limited to, nut chunks, candied bits, cereals (e.g., toasted crisp rice such as Rice Krispies® available from the Kellogg Company, Battle Creek, Mich.), dried fruit bits (e.g., raisins), and mixtures thereof.

The super-stabilized nut spread and food bits are combined to form a mixture that is used to form the center of the snack bar. Preferably, the super-stabilized nut spread is thoroughly admixed with the food bits while in the melted state. Alternately, the super-stabilized nut spread, once cooled, can be admixed with the food bits and the total mixture heated to re-melt the super-stabilized portion of the product.

If the particular food bits being used are fragile, extensive mixing may cause significant particle size reduction, which in turn may weaken the overall finished structure. The degree of mixing should therefore be limited to that necessary to thoroughly disperse the food bits.

The mixture comprises from about 50 ml to about 250 ml, preferably from about 100 ml to about 200 ml, of food bits per 100 g of the total weight of the mixture (comprising food bits+super-stabilized nut spread). When combined with food bits, the super-stabilized nut spread retains is nut spread flavor and creaminess, yet has the desired structural strength for bar formation and stability against oil separation. Furthermore, the addition of food bits to the super-stabilized nut spread reduces the amount of stabilizer that must be added to the nut spread, thus avoiding a waxy mouthfeel and the loss of nut flavor.

The density of the resulting snack bar center is preferably from about 0.5 to about 1.25 g/ml, more preferably from about 0.6 to about 1.1 g/ml.

4. Snack Bar Formation

In the preferred process, the super-stabilized nut spread is melted and mixed with the food bits. While this mixture is still in its melted state, it is formed into the final shape and allowed to cool and firm up. It can either be formed into individual bars, or can be lo formed into sheets that can later be cut into bar shapes.

An alternate process to prepare the bars comprises taking unmelted super-stabilized nut spread and mixing it directly with the desired level of bits while at room temperature (˜70° F. (˜21° C.)). This mixture can then be formed into bars or sheets. The mixture must next be heated to melt the super-stabilized nut spread. Heating can be accomplished by any number of means, such as but not limited to microwaving, convection oven, or radiant heating. The key requirement is to raise the product temperature above the complete melt point of the super-stabilized nut spread. In most cases, this requires the product temperature to reach above 150° F. (66° C.). Once this temperature is reached, the finished shapes are allowed to cool and firm up.

Once firm, these shapes can either be used as is or can be further coated (“enrobed”) with a variety of coatings.

5. Enrobing the Snack Bar

Optionally, but preferably, the snack bar is enrobed with a confectioner's material or other suitable material to form an enrobed snack bar. The enrobed snack bar comprises greater than about 30%, preferably from about 45% to about 80%, nut spread. For example, commercially available coating materials based upon cocoa butter or compound coatings based upon hardened vegetable oils may be used. Suitable coatings can include, but are not limited to, those that are chocolate flavored, vanilla flavored, peanut flavored, yogurt flavored, coconut flavored, fruit flavored, or the like. Mixtures of confectioner's coatings may also be used.

Preferably, the confectioner's coating material is melted by heating it to its melting point or to within about 10° F. (5° C.) above its melting point. The melted coating material is then applied to the snack bar by any suitable method, such as dipping, pouring, spreading, or the like.

The enrobed snack bar may additionally be topped with toppings such as granola, crushed nuts, additional food bits, or any other desired topping to enhance the flavor and visual appeal. Suitable topping amounts are from about 0% to about 5% by weight of the final enrobed snack bar.

6. Optional Ingredients

The center of the bar may optionally include other desired ingredients. These ingredients can include, but are not limited to, dry components and liquid oil soluble components. Examples of dry components (e.g., components smaller than the food bits used herein) include vitamins, fiber, protein, calcium, and the like. It should be noted that since these dry components may provide some stabilization, it may be possible to use slightly lower levels of stabilizer when using optional dry components than otherwise would be needed. Examples of liquid oil soluble components are antioxidants such as tocopherols, oil based emulsifiers, flavor compounds, and the like. It should be noted that if the level of liquid oil soluble components added is significant, a slightly higher level of stabilizer may be required than otherwise would be needed.

7. Snack Bar Characteristics

The finished snack bar has a high level of nut flavor, good bar strength, is not sticky or tacky, and has a good mouthfeel (e.g., not waxy). The snack bar has a Bar Strength (supportable length) of at least about 2 inches (5 cm), preferably from about 3 inches (8 cm) to about 8 inches (20 cm), more preferably from about 3 inches (8 cm) to about 6 inches (15 cm), measured as described in the Analytical Methods section herein.

### ANALYTICAL METHODS

All instruction guides and users' manuals should be followed in performing the analyses below unless noted otherwise.

1. Bar Strength (Supportable Length)

This test was developed to judge the structural strength of bars made with various formulations. A simple test of bar strength is represented by the maximum length that the bar can support itself. For this test a sheet of bar material is prepared ½ inch (1.3 cm) thick and allowed to set up overnight at room temperature (˜70° F. (˜21° C.)). From this sheet a bar 6 inches (15 cm) long and 1¼ inches (3.2 cm) wide is cut. This bar is placed on a metal spatula. The bar is held on the spatula by gripping the last ½ inch (1.3 cm) of the bar with the fingers. (The metal spatula must be wider than the width of the bar.) The bar is then slowly pushed off the end of the metal spatula and the length of the bar extending over the end of the spatula is monitored. The distance, in inches (cm), is recorded when the bar either breaks or experiences a significant amount of sag. For the purposes of this test a significant amount of sag is defined as more than ½ inch (1.3 cm) of deflection from the horizontal. Total elapsed test time is 10 seconds (from the moment the bar begins being slid off the end of the spatula to the time that the entire bar is pushed off the edge and the amount of sag or breakage is noted).

2. Penetration Value

“Penetration” is a measure of the firmness or consistency of a nut spread. Penetration is determined by measuring the distance a given weight (47 grams) of defined shape will penetrate the nut spread after falling from a height of 2 centimeters above the surface of the nut spread. The penetration of the nut spread is related to its composition and processing, and to the temperature of the sample at the time of measurement. The detailed method for measuring penetration is described below. Penetration is measured in units of millimeters/10 at 21° C.

Principle: Firmness of the nut spread is measured with a modified Precision Universal penetrometer. Penetration is a measure of the consistency of a material expressed as the distance that a standard needle vertically penetrates the sample under known conditions of loading, time, and temperature.

Limitations: A large amount of entrained air will affect nut spread consistency and cause abnormal penetrometer readings. Penetration on top of a nut granule or other bit material will give an abnormally low reading; readings should therefore be made on bit-free material.

Sample Preparation: To prepare the nut spread sample for testing, the fully melted nut spread is placed into a jar and allowed to cool overnight at a temperature of 21.1±0.5° C. The sample is then ready for testing. (The penetration value is recorded as mm/10 at 21° C.)

Test Method: The detailed method for measuring penetration is described in U.S. Pat. No. 4,996,074 to Seiden & White, issued Feb. 26, 1991, at column 25, line 65 to column 27, line 63 and FIG. 1 +L, this patent of which is herein incorporated by reference in its entirety.

### EXAMPLES

The following examples are representative of the present invention, but are not meant to be limiting thereof.

### Example 1

Formula:

| | Wt | | Bit Volume |
|---|---|---|---|
| Material | (g) | Wt % | (ml/100 g) |
| Jif ® Creamy Style Peanut Butter | 270 | 57.6 | — |
| Chopped Peanuts | 133 | 28.4 | 46.6 |
| Stabilizer | 5.4 | 1.2 | — |
| Rice Krispies ® | 60 | 12.8 | 102.4 |
| Total | 468.4 | 100 | 149 |

The creamy peanut butter is fully melted by heating to 150° F. (66° C.) on a range top. The melted stabilizer, comprised of a 50/50 mixture of fully hydrogenated soybean and rapeseed oils, is then added to the peanut butter. This melted mixture is combined with the chopped peanuts and the Rice Krispies®. The mixture is then poured onto a cookie sheet and rolled out to approximately ½ inch (1.3 cm) thickness. The sheet is allowed to cool at room temperature (˜70° F. (˜21° C.)) and the peanut butter is allowed to set up. The cooled sheet is then coated on both sides with a confectioner's candy coating and then cut into bars. The resulting bars have good eating quality and are very high in peanut butter flavor.

### Example 2

### Preparation of Super-Stabilized Peanut Butter

Jif® Crunchy Peanut Butter, comprising 75% creamy peanut butter and 25% chopped peanut chunks, is used. 400 pounds (180 kg) of the crunchy style peanut butter is melted by heating to 150° F. (66° C.) in an agitated, water jacketed kettle. To this melted crunchy style peanut butter, 8 pounds (3.6 kg) of melted stabilizer is added. The stabilizer is comprised of a 50/50 mixture of fully hydrogenated soybean and rapeseed oils. The blend is well mixed and pumped into 5 gallon (19 L) pails and allowed to cool under ambient conditions.

### Example 3

Formula:

| | Wt | | Bit Volume |
|---|---|---|---|
| Material | (g) | % | (ml/100 g) |
| Super stabilized Crunchy Peanut | | | |
| Butter as prepared in Example 2: | | | |
| Creamy Peanut Butter | 1364 | 56 | — |
| Chopped Peanuts | 455 | 18.7 | 31 |
| Stabilizer | 37 | 1.5 | — |
| Rice Krispies ® | 579 | 23.8 | 190 |
| Total | 2435 | 100 | 221 |

The super-stabilized crunchy style peanut butter is fully melted at 150° F. (66° C.). This melted mixture is combined with the Rice Krispies® and thoroughly mixed. The mixture is then poured onto a 16×25 inch (41×64 cm) tray and rolled out to approximately ⅝ inch (1.6 cm) thickness. The sheet is allowed to cool at room temperature (˜70° F. (˜21° C.)) and the peanut butter is allowed to set up. The cooled sheet is then coated on both sides with a confectioner's coating and then cut into bars. The resulting bars have good eating quality and are very high in peanut butter flavor.

### Example 4

Formula:

| | Wt | | Bit Volume |
|---|---|---|---|
| Material | (g) | % | (ml/100 g) |
| Super stabilized Crunchy Peanut | | | |
| Butter as prepared in Example 2: | | | |
| Creamy Peanut Butter | 482 | 62.4 | — |
| Chopped Peanuts | 161 | 20.9 | 34 |
| Stabilizer | 13 | 1.7 | — |
| Rice Krispies ® | 116 | 15 | 120 |
| Total | 772 | 100 | 154 |

The super-stabilized peanut butter prepared in Example 2 is allowed to solidify at room temperature (˜70° F. (˜21° C.)). 656 grams of this room temperature mixture is combined with 116 grams of toasted rice cereal (Rice Krispies®). This mixture is then transferred onto a 9×13 inch (23×33 cm) pan and rolled out to approximately ⅝ inch (1.6 cm) thickness. The mixture is then baked in an oven at 200° F. (93° C.) for 20 minutes (1200 sec). After 20 minutes (1200 sec) the product temperature has reached 150° F. (66° C.). The baked sheet is allowed to cool and set up over night. The resulting bars have good structural strength, have good eating quality and are very high in peanut butter flavor.

### Example 5

Formula:

| | Wt | | Bit Volume |
|---|---|---|---|
| Material | (g) | % | (ml/100 g) |
| Jif Smooth Sensations ® Berry | 270 | 57.6 | — |
| Blend | | | |
| Stabilizer | 133 | 28.4 | 46.6 |
| Chopped Peanuts | 5.4 | 1.2 | — |
| Rice Krispies ® | 60 | 12.8 | 102.4 |
| Total | 468.4 | 100 | 149 |

The Jif Smooth Sensations® Berry Blend peanut butter is fully melted by heating to 150° F. (66° C.) on a range top. The melted stabilizer, comprised of a 50/50 mixture of fully hydrogenated soybean and rapeseed oils, is then added to the peanut butter. This melted mixture is combined with the chopped peanuts and the Rice Krispies®. The mixture is then poured onto a cookie sheet and rolled out to approximately ½ inch (1.3 cm) thickness. The sheet is allowed to cool at room temperature (˜70° F. (˜21° C.)) and the peanut butter is allowed to set up. The cooled sheet is then coated on both sides with a confectioner's coating and then cut into bars. The resulting bars have good eating quality and are very high in nut butter flavor.

### INCORPORATION BY REFERENCE

All of the aforementioned patents, applications, publications, and other references referred to herein are incorporated by reference in their entirety.

What is claimed is:

1. A snack bar comprising a center portion, wherein said center portion comprises at least about 45% super-stabilized nut spread.

2. The snack bar of claim 1, wherein said super-stabilized nut spread comprises from about 1% to about 4% added stabilizer.

3. The snack bar of claim 2, wherein said super-stabilized nut spread has a penetration value of from about 130 to about 300 penetration units (mm/10) at 21° C.

4. The snack bar of claim 3, wherein said center portion comprises from about 50 ml to about 250 ml of food bits per 100 g of the total weight of the center portion.

5. The snack bar of claim 4, wherein said center portion has a density of from about 0.5 to about 1.25 g/ml.

6. The snack bar of claim 5, wherein said center portion has a density of from about 0.6 to about 1.1 g/ml.

7. The snack bar of claim 6, wherein said snack bar has a Bar Strength of at least about 2 inches (5 cm).

8. The snack bar of claim 7, wherein said super-stabilized nut spread is peanut spread.

9. The snack bar of claim 8, wherein said super-stabilized nut spread is peanut butter.

10. The snack bar of claim 9, wherein said snack bar is enrobed with a confectioner's material.

11. The snack bar of claim 1, wherein said center portion comprises from about 60% to about 95% super-stabilized nut spread.

12. The snack bar of claim 11, wherein said super-stabilized nut spread comprises from about 1% to about 4% added stabilizer.

13. The snack bar of claim 12, wherein said super-stabilized nut spread has a penetration value of from about 150 to about 250 penetration units (mm/10) at 21° C.

14. The snack bar of claim 13, wherein said center portion comprises from about 100 ml to about 200 ml of food bits per 100 g of the total weight of the center portion.

15. The snack bar of claim 14, wherein said center portion has a density of from about 0.5 to about 1.25 g/ml.

16. The snack bar of claim 15, wherein said center portion has a density of from about 0.6 to about 1.1 g/ml.

17. The snack bar of claim 16, wherein said snack bar has a Bar Strength of from about 3 inches (8 cm) to about 8 inches (20 cm).

18. The snack bar of claim 17, wherein said super-stabilized nut spread is peanut spread.

19. The snack bar of claim 18, wherein said super-stabilized nut spread is peanut butter.

20. The snack bar of claim 19, wherein said snack bar is enrobed with a confectioner's material.

21. A process for making a snack bar, wherein said process comprises the steps of:
(a) providing a nut spread;
(b) adding a sufficient quantity of stabilizer to the nut spread to form a super-stabilized nut spread having a penetration value of from about 130 to about 300 penetration units (mm/10) at 21° C.;
(c) adding food bits to the super-stabilized nut spread to form a mixture, wherein said mixture comprises from about 50 ml to about 250 ml of food bits per 100 g of the total weight of the mixture; and
(d) forming the mixture into a bar shape.

22. The process of claim 21, wherein said snack bar comprises at least about 45% super-stabilized nut spread.

23. The process of claim 22, wherein said snack bar comprises from about 60% to about 95% super-stabilized nut spread.

24. The process of claim 21, comprising the additional step of:
(e) enrobing the snack bar with a confectioner's material to form an enrobed snack bar.

25. The process of claim 24, wherein said enrobed snack bar comprises greater than about 30% super-stabilized nut spread.

26. The process of claim 25, wherein said enrobed snack bar comprises from about 45% to about 80% super-stabilized nut spread.

27. The process of claim 21, wherein said super-stabilized nut spread has a penetration value of from about 150 to about 250 penetration units (mm/10) at 21° C.

28. The process of claim 27, wherein said snack bar has a Bar Strength of at least about 2 inches (5 cm).

29. The process of claim 28, wherein said snack bar has a Bar Strength of from about 3 inches (8 cm) to about 8 inches (20 cm).
